(19) United States
(12) Patent Application Publication
(10) Pub. No.: US 2026/0110705 A1
(43) Pub. Date: Apr. 23, 2026

(54) METHOD FOR TEMPERATURE COMPENSATION OF A SENSOR MEASUREMENT VALUE OF A SENSOR

(71) Applicant: AUMOVIO Germany GmbH, Frankfurt am Main (DE)

(72) Inventors: Eduard Bleicher, Burglengenfeld (DE); Marko Piering, Barbing (DE); Roland Hilser, Kirchheim (DE); Herbert Preis, Bach a.d. Donau (DE)

(73) Assignee: AUMOVIO Germany GmbH, Frankfurt am Main (DE)

(21) Appl. No.: 19/362,509

(22) Filed: Oct. 20, 2025

(30) Foreign Application Priority Data
Oct. 18, 2024 (DE) 10 2024 210 105.2

(51) Int. Cl. G01P 1/00

(52) U.S. Cl. CPC G01P 1/006

(57) ABSTRACT

A method for temperature compensation of a sensor measurement value of a sensor in a vehicle's safety system during vehicle operation, wherein the sensor comprises predetermined temperature compensation data for a predetermined temperature compensation, which are stored in readable fashion in a memory unit of the sensor. The vehicle has an electronic control unit which performs an algorithm for improving the temperature compensation by way of a temperature compensation that is more extensive than the predetermined temperature compensation, and wherein the stored temperature compensation data are made available to the algorithm as a basis for the more extensive temperature compensation.

### TECHNICAL FIELD

A device and method for temperature compensation of a sensor measurement value of a sensor in a vehicle's driver assistance system or safety system during vehicle operation are disclosed.

### BACKGROUND

Sensors used in a vehicle, for example acceleration sensors, usually deliver output or measurement signals for a sensor measurement variable acting on the sensor and detected by the sensor. It is known in this case that the relationship between the output signal and the detected sensor measurement variable varies between sensors of the same sensor type or even sensors that are of identical design. In the case of many sensors, fluctuations, distortions or inaccuracies in the sensor measurement variable detected thereby or in the sensor measurement values determined or generated thereby occur on account of production-related, environment-related and/or operation-related effects. Depending on the sensor, sensor type or effect, this can have a different effect on the sensor measurement values determined or generated. In addition to a simple offset, that is to say a shift or an offset of the respective sensor measurement values by a constant or parameter-dependent value, more complex distortions can also occur. For example, a relationship between a sensor measurement variable acting on the sensor and the associated sensor measurement value detected or determined by the sensor can have a parameter dependency. Likewise, a parameter-dependent non-linear characteristic curve can result between the sensor measurement variable acting on the sensor and the sensor measurement value detected or determined by the sensor.

For example, sensors have a temperature dependency which is physically unavoidable, which is determined above all by a thermal offset and a thermal sensitivity. The sensors may thus react sensitively to temperature changes, that is to say corresponding fluctuations, distortions or inaccuracies may be dependent on a temperature of the sensor.

In order to reduce this sensitivity of the sensors and thus to improve the accuracy of the measurements with the sensors, the sensors are usually subjected by the sensor manufacturer to a characterization or calibration process during production or manufacture in the factory. In this context, different values of the sensor measurement variable are generally applied to the sensor in a heat chamber at different, predetermined temperatures or temperature values, and the respective output signal of the sensor is detected. In such a characterization or calibration process, several data sets can be detected at different temperatures. A regression analysis is then applied, for example, to the detected data in order to reflect the thermal sensitivity of the sensor, wherein the coefficients obtained from the regression analysis are then stored in a memory unit of the sensor as predetermined temperature compensation data, and wherein these predetermined temperature compensation data are then applied by the sensor during (vehicle) operation in the application situation for a predetermined temperature compensation, that is to say for predetermined compensation of temperature-related deviations of the sensor measurement values.

However, such a correction or compensation of temperature-related offset and sensitivity inaccuracies of the sensor measurement values neglects the influence of individual factors, such as for example production-related individual properties of an individual, specific sensor. In addition, the factory characterization or calibration process is performed only at isolated, predetermined temperatures and only within a certain temperature range. Therefore, such a factory-predetermined temperature compensation is not sufficient to be able to achieve an extensive correction or compensation which is required specifically for sensor measurement values that are used by current driver assistance systems or safety systems of a modern vehicle in order to ensure safe functionality and sufficiently high reliability of the driving assistance or safety systems. There is therefore a need for an individual correction or compensation of temperature-related measurement inaccuracies that is adaptable to a specific sensor and its specific and current temperature behavior, and is thus extensive, and which corresponds to current requirements for driver assistance systems or safety systems. It is also important that such an extensive correction or compensation is available during vehicle operation as quickly as possible or at an early stage.

### SUMMARY

Against this, it is now an object to specify an improved method for temperature compensation of a sensor measurement value of a sensor in a vehicle's driver assistance system or safety system during vehicle operation and a corresponding device which reliably enables efficient and extensive temperature compensation.

A method for temperature compensation of a sensor measurement value of a sensor in a vehicle's driver assistance system or safety system during vehicle operation, wherein the sensor comprises predetermined temperature compensation data for a predetermined temperature compensation, which are stored in readable fashion in a memory unit of the sensor, wherein the vehicle has an electronic control unit which performs an algorithm for improving the temperature compensation by way of a temperature compensation that is more extensive than the predetermined temperature compensation, and wherein the stored temperature compensation data are made available to the algorithm as a basis for the more extensive temperature compensation.

Therefore based on the fact that, in order to improve the temperature compensation, a more extensive temperature compensation than the predetermined temperature compensation is carried out by means of an algorithm which is implemented in an electronic control unit of the vehicle, and that the predetermined temperature compensation data are stored in readable fashion in the memory unit of the sensor, wherein said predetermined temperature compensation data are provided during vehicle operation to the algorithm and used as a basis for the more extensive temperature compensation. As a result of this read-out facility and the actual reading out or provision of the predetermined temperature compensation data, the predetermined temperature compensation data are thus available to the algorithm for the more extensive temperature compensation, and the acquired knowledge of the predetermined temperature compensation data, for example of a temperature behavior of the sensor, can thus be directly used as a basis or starting point for the more extensive temperature compensation as a result of which a improvement in the temperature compensation and thus in the accuracy of a sensor measurement value can then be achieved by means of the more extensive temperature compensation.

The refinement consequently provides a method which allows efficient and extensive temperature compensation.

The method for temperature compensation thus serves to compensate for temperature influences on the measurement signals or sensor measurement values of a sensor measurement variable of a sensor during vehicle operation, for example for compensating temperature-induced deviations and/or a temperature-dependent offset of the sensor measurement values. In this case, in the context of temperature compensation on the basis of temperature compensation data of the sensor, which are predetermined by a sensor manufacturer at the factory, first of all a predetermined temperature compensation of a sensor measurement value takes place, and then by the algorithm for improving the temperature compensation a more extensive compensation of temperature-related deviations of the sensor measurement value than the predetermined temperature compensation is performed, wherein the algorithm uses the stored and read predetermined temperature compensation data as a basis for the more extensive temperature compensation. Here, the more extensive temperature compensation supplements the predetermined temperature compensation.

The predetermined temperature compensation is designed to adapt or correct the sensor measurement variable detected by the sensor or the sensor measurement value determined by the sensor on the basis of the predetermined temperature compensation data for any desired current temperature value, for example of a temperature range that is predetermined at the factory, and to generate and provide a correspondingly adapted or corrected sensor measurement value. The predetermined temperature compensation is may be carried out in or by the sensor itself.

The predetermined temperature compensation data are for example configured or stored as immutable, that is to say non-variable, temperature compensation data. For example, the predetermined temperature compensation data have been acquired at the factory by the sensor manufacturer and stored in readable fashion in the memory unit of the sensor.

The provision of the stored temperature compensation data may be realized in that the algorithm or a computing unit, for example in the form of a microcontroller, of the electronic control unit which executes the algorithm, reads out the stored temperature compensation data directly or indirectly from the memory unit of the sensor, or in that the stored temperature compensation data are sent or transmitted directly or indirectly by the sensor to the algorithm or to a computing unit, for example in the form of a microcontroller, of the electronic control unit.

During vehicle operation, the sensor detects a sensor measurement variable and determines sensor measurement values of the sensor measurement variable, wherein the predetermined temperature compensation may be applied to the sensor measurement values determined by the sensor on the basis of the predetermined temperature compensation data. The fact that the sensor is a sensor of a driver assistance system or safety system of the vehicle can be understood to mean that the more extensively temperature-compensated sensor measurement values of the sensor are ultimately (further) processed or evaluated by the driver assistance system or safety system and used, for example, to generate a decision about the control of an actuator of the driver assistance system or safety system. The sensor can thus be assigned directly to the driver assistance system or safety system, that is to say it can be a direct component of the driver assistance system or safety system. However, the sensor may also not be assigned directly to the driver assistance system or safety system, that is to say can not be a direct component of the driver assistance system or safety system, that is to say it can be assigned for example to a vehicle system different than the driver assistance system or safety system, or to a sensor cluster of the vehicle.

The electronic control unit is designed, for example, as an electronic control unit of a sensor cluster of the vehicle to which the sensor is assigned, or as an electronic control unit of the driver assistance system or safety system, for example as an airbag control unit (ACU). The electronic control unit has a computing unit, for example in the form of a microcontroller, wherein the computing unit executes the algorithm for improving the temperature compensation. For example, the electronic control unit is not part of the sensor.

The driver assistance system may comprise a driving assistance program and can be designed to at least assist a driver of the vehicle in specific driving tasks or in a critical driving scenario and thereby to increase active road safety and/or driving comfort. The driver assistance system may be designed here as a partially or fully automated driver assistance system which assists the driver of the vehicle by means of an autonomous or automatic intervention and in so doing at least partially takes over control or guidance of the vehicle for a certain period of time and/or outputs an assistive warning signal to the driver. For example, the driver assistance system is designed as a system for adaptive cruise control, a lane keep assistance system, a lane change assistance system, a brake assistance system or an emergency steering assistance system. The safety system may comprise a safety program and may be designed as an occupant warning system or an occupant protection system, wherein an occupant protection system can have, for example, a vehicle seat adjuster or an occupant restraint device, for example an airbag or a belt tensioner.

A sensor measurement variable may be understood to be a physical variable that can be detected by means of the sensor. This may for example be an acceleration, a rate of rotation or a pressure.

Temperature-induced deviations of a sensor measurement value may be understood as for example temperature-induced deviations of the sensor measurement value from the actual value of the sensor measurement variable.

The vehicle or the driver assistance system or safety system additionally comprises a temperature sensor unit for detecting a temperature, for example a temperature of the sensor.

In one embodiment, within the scope of the more extensive temperature compensation, a larger and/or supplementary temperature range is encompassed in comparison with the predetermined temperature compensation. The predetermined temperature compensation and the corresponding predetermined temperature compensation data are in this case stipulated in advance, for example at the factory by the sensor manufacturer, for a (pre-)determined temperature range. As a result of the more extensive temperature compensation, a larger and/or supplementary temperature range with respect to this predetermined temperature range is now comprised, that is to say covered.

In a further embodiment, as part of the more extensive temperature compensation, for example for a predetermined temperature range and/or for predetermined temperature values, a sensor error is further reduced compared to the predetermined temperature compensation. The predetermined temperature range is for example a temperature range (pre-)determined by the sensor manufacturer at the factory for which the predetermined temperature compensation data for the predetermined compensation were determined. The predetermined temperature values are for example temperature values (pre-)determined by the sensor manufacturer at the factory, for which the predetermined temperature compensation data for the predetermined compensation were determined. The sensor error is for example in the form of a temperature-related deviation of the sensor measurement value from the actual value of the sensor measurement variable that remains despite carrying out the predetermined temperature compensation.

In a further embodiment, for the more extensive temperature compensation, the algorithm ascertains more extensive temperature compensation data based on the predetermined temperature compensation data, wherein the more extensive temperature compensation data are used for the more extensive temperature compensation. In this case, namely during vehicle operation, that is to say in the application situation, the algorithm determines more extensive temperature compensation data specifically for the specific sensor. On the basis of these more extensive temperature compensation data and the corresponding more extensive temperature compensation, it is possible for example to compensate for temperature influences on the sensor measurement values which take into account, for example, assembly-related and environment-related influences in the installed state of the sensor in the vehicle and/or the specific component-specific temperature behavior and/or changes in the temperature behavior over the lifetime of the sensor and/or a more extensive temperature range different from a predetermined temperature range, for example a larger and/or supplementary temperature range with respect to the predetermined temperature range.

In a further embodiment, the more extensive temperature compensation data are acquired during a learning phase, wherein the more extensive temperature compensation data are used for a more extensive temperature compensation only after the conclusion of the learning phase. During vehicle operation, that is to say initially during the learning phase, the algorithm learns or determines as extensively and accurately as possible the actual temperature behavior of the sensor and, based on this, the corresponding more extensive temperature compensation data. As a result of the stored predetermined temperature compensation data being provided to the algorithm as a basis for the more extensive temperature compensation, the expenditure, for example the expenditure of time, for the learning phase can be reduced and the learning phase for the algorithm can thus be shortened, whereby the algorithm is already ready for use after a short time for performing the more extensive temperature compensation.

In a further embodiment, the algorithm for determining the more extensive temperature compensation data is furthermore provided with a current temperature value and an associated current sensor measurement value as a pair of values in the presence of a predefined measurement situation, wherein the algorithm determines more extensive temperature compensation data on the basis of the predetermined temperature compensation data and the pair of values.

In a further embodiment, the more extensive temperature compensation data are ascertained for a more extensive temperature range which differs from a predetermined temperature range, for example is larger than and/or supplementary to the predetermined temperature range, and/or for temperature values which differ from predetermined temperature values. The predetermined temperature range is for example a (pre-)determined temperature range stipulated in advance at the factory by the sensor manufacturer, for which the predetermined temperature compensation data were determined for the predetermined temperature compensation. The predetermined temperature values are in particular (pre-)determined temperature values stipulated in advance at the factory by the sensor manufacturer, for which the predetermined temperature compensation data were determined for the predetermined temperature compensation.

In a further embodiment, the predetermined temperature compensation data, for example for a predetermined temperature range, describe a temperature influence on a sensor measurement variable of the sensor and/or a temperature-induced sensor error. The predetermined temperature compensation data can be, for example, parameters of a model or a mathematical function by means of which a temperature profile of the sensor measurement variable can be described. The predetermined temperature compensation data can be configured, for example, as coefficients and/or constants of a function which describes a functional relationship between the temperature and the sensor measurement variable in a reference measurement situation within a predetermined temperature range. The predetermined temperature compensation data can also be in the form of a temperature-dependent offset and/or a temperature-dependent sensitivity of the sensor, for example. The temperature-induced sensor error may be, for example, a sensor (residual) error that is still present despite the use or application of the predetermined temperature compensation.

In a further embodiment, in which, for the more extensive temperature compensation, the algorithm determines more extensive temperature compensation data on the basis of the predetermined temperature compensation data, wherein the more extensive temperature compensation data are used for the more extensive temperature compensation, the more extensive temperature compensation data can likewise be parameters of a model or of a mathematical function, for example, by means of which a temperature profile of the sensor measurement variable can be described. The predetermined temperature compensation data can be configured, for example, as coefficients and/or constants of a function which describe a functional relationship between the temperature and the sensor measurement variable in a reference measurement situation within a predetermined temperature range.

In a further embodiment, the sensor is designed as an inertial sensor, for example as an acceleration sensor or rotation rate sensor. If the sensor is in the form of an acceleration sensor, for example, the sensor measurement variable is for example an acceleration or a variable derived from an acceleration. If the sensor is designed as a rotation rate sensor, for example, the sensor measurement variable is, for example, a rate of rotation or an angular velocity or a variable derived from a rate of rotation or angular velocity.

In a further embodiment, the electronic control unit is designed as an electronic control unit of the driver assistance system or safety system, wherein the electronic control unit executes a driving assistance program or safety program. At least the more extensively temperature-compensated sensor measurement values of the sensor are (further) processed or evaluated by or in the driving assistance program or safety program, for example in order to generate a decision about the control of an actuator of the driver assistance system or safety system. The driving assistance program or safety program may be executed on a computing unit, for example in the form of a microcontroller, of the electronic control unit.

In this case, in a further embodiment, the algorithm for the temperature compensation is implemented in the driver assistance program or safety program. The algorithm for a more extensive temperature compensation is therefore additionally implemented in the driving assistance program or safety program, and the driving assistance program or the safety program thus comprises the algorithm for more extensive temperature compensation.

The present embodiments also comprises a device for a vehicle, wherein the device comprises a sensor and an electronic control unit, and wherein the device is designed or configured for carrying out the method.

### BRIEF DESCRIPTION OF THE DRAWINGS

In the following, exemplary embodiments will be elucidated in greater detail based on a drawing. In the figures:

FIG. 1 shows a flowchart of a method for temperature compensation of a sensor measurement value of a rotation rate sensor of an occupant protection system of a vehicle during vehicle operation,

FIG. 2a shows a diagram that illustrates a profile of a tolerance of a sensor measurement value of the rotation rate sensor as a function of the temperature after performing the predetermined temperature compensation of the method according to FIG. 1, and

FIG. 2b shows a diagram that illustrates a profile of a tolerance of a sensor measurement value of the rotation rate sensor as a function of the temperature after performing the more extensive temperature compensation of the method according to FIG. 1.

### DETAILED DESCRIPTION

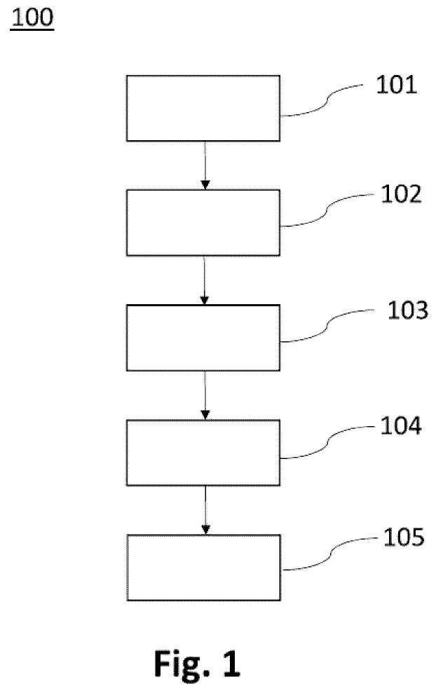

FIG. 1 shows a flowchart of a method 100 for temperature compensation of a sensor measurement value of a rotation rate sensor of an occupant protection system of a vehicle during vehicle operation, The occupant protection system additionally comprises a temperature sensor for determining a current temperature of the rotation rate sensor, an electronic control unit and an occupant restraint system designed as a driver airbag.

The rotation rate sensor is designed to detect current rotation rates of the vehicle. A memory unit of the rotation rate sensor stores temperature compensation data predetermined by the rotation rate sensor manufacturer in a readable manner at the factory, wherein the rotation rate sensor is further designed to apply a predetermined temperature compensation to the sensor measurement values determined by the rotation rate sensor based on the predetermined temperature compensation data in order to generate correspondingly temperature-compensated sensor measurement values and to provide them to the control unit for further processing.

For this purpose, the electronic control unit carries out, for example, a safety program by means of which a decision is ultimately made, for example, about controlling or triggering of the occupant restraint device on the basis of the sensor measurement values processed by the safety program. Also, the safety program implements an algorithm for the temperature compensation of the sensor measurement value by means of more extensive temperature compensation based on more extensive temperature compensation data that goes further than the predetermined temperature compensation, wherein the safety program is designed to perform the algorithm and the more extensive temperature compensation before further processing of the sensor measurement values, for example before further processing of the sensor measurement value to generate a decision about controlling or triggering of the occupant protection device.

In order to determine the more extensive temperature compensation data required for the more extensive temperature compensation, while the vehicle is operating, during a learning phase of the algorithm, initially, in step 101, the predetermined temperature compensation data stored (in readable fashion) in the memory of the rotation rate sensor are first read by the safety program and are provided to the algorithm as a starting point or basis for the corresponding determination. As a result, the expenditure, for example the time expended, for the learning phase is reduced and the learning phase for the algorithm is thus shortened, as a result of which the algorithm is already ready for use after a short time for actually carrying out the more extensive temperature compensation.

In a subsequent step 102, current temperature values of the temperature sensor and respectively associated current sensor measurement values of the rotation rate sensor are provided to the algorithm (which is still in the learning phase) as corresponding pairs of values in the presence of predefined measurement situations, and the algorithm then determines the more extensive temperature compensation data on the basis of the provided predetermined temperature compensation data and the provided pairs of values. As soon as these more extensive temperature compensation data have been determined, the learning phase is complete.

In a next step 103, the rotation rate sensor detects a current rate of rotation of the vehicle and a corresponding sensor measurement value is determined, wherein the predetermined temperature compensation is applied to the sensor measurement value. The correspondingly generated sensor measurement value is then supplied to the control unit or safety program for further processing.

In a next step 104, the algorithm of the safety program first carries out the more extensive temperature compensation of the sensor measurement value based on the determined more extensive temperature compensation data.

In a step 105, the correspondingly more extensively temperature-compensated sensor measurement value is then processed further by the safety program to generate a decision about the actuation or triggering of the occupant protection device.

By virtue of such a configuration, for example by virtue of the readout facility and the actual reading of the predetermined temperature compensation data, the predetermined temperature compensation data are thus immediately available to the algorithm for the more extensive temperature compensation, and the acquired knowledge of the predetermined temperature compensation data, for example of a temperature behavior of the rotation rate sensor, can thus be directly used as a basis or starting point for the determination of the more extensive temperature compensation data, as a result of which the algorithm is already ready for use after a short time to carry out the more extensive temperature compensation. As a result, an improvement in the temperature compensation and thus in the accuracy of a sensor measurement value can be achieved.

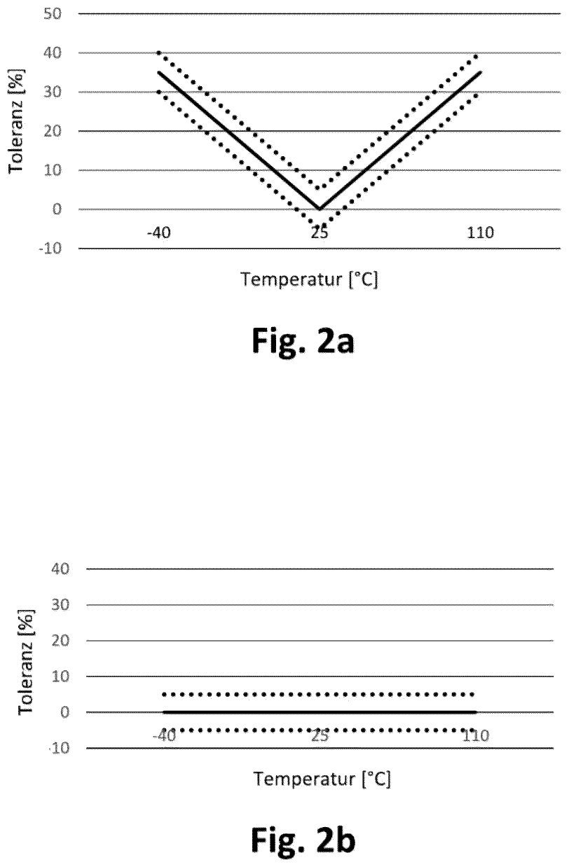

FIG. 2a shows a diagram that illustrates a profile of a tolerance of a sensor measurement value of the rotation rate sensor as a function of the temperature after performing the predetermined temperature compensation of the method 100 according to FIG. 1.

FIG. 2b shows a diagram that illustrates a profile of a tolerance of a sensor measurement value of the rotation rate sensor as a function of the temperature after performing the more extensive temperature compensation of the method 100 according to FIG. 1.

From the diagrams illustrated in FIGS. 2a-2b, the temperature compensation and thus the accuracy of a sensor measurement value of the rotation rate sensor resulting from step 104, that is to say the performance of the more extensive temperature compensation by the algorithm of the safety program, can be seen.

1. A method for temperature compensation of a sensor measurement value of a sensor in a safety system during vehicle operation comprising:
storing predetermined temperature compensation data in readable fashion in a memory unit of the sensor,
making the stored temperature compensation data available to an algorithm for the temperature with an electronic control unit; and
performing the algorithm for the temperature compensation on the basis of the predetermined temperature compensation data.

2. The method according to claim 1, wherein the algorithm for temperature compensation has a temperature range which is larger than the predetermined temperature compensation is comprised.

3. The method according to claim 1, wherein the algorithm for temperature compensation, for one of a predetermined temperature range and for predetermined temperature values, results in a reduction in a sensor error takes place which is more extensive than in the predetermined temperature compensation.

4. The method according to claim 1, wherein the algorithm for temperature compensation determines more extensive temperature compensation data based on the predetermined temperature compensation data, and wherein the more extensive temperature compensation data are used for the algorithm for temperature compensation.

5. The method according to claim 4, wherein the algorithm determines the more extensive temperature compensation data during a learning phase, and wherein the more extensive temperature compensation data are used for a more extensive temperature compensation only after the conclusion of the learning phase.

6. The method according to claim 4, further comprising:
providing a current temperature value and an associated current sensor measurement value are also provided to the algorithm as a pair of values when a predefined measurement situation is present to determine the more extensive temperature compensation data; and
determining with the algorithm the more extensive temperature compensation data on the basis of the pair of values.

7. The method according to claim 4, wherein the more extensive temperature compensation data are determined for the more extensive temperature range which is at least one of: larger than the predetermined temperature range, supplementary to the predetermined temperature range, and for temperature values which differ from predetermined temperature values.

8. The method according to claim 1, wherein the predetermined temperature compensation data describe at least one of a temperature influence on a sensor measurement variable of the sensor and a temperature-induced sensor error.

9. The method according to claim 1, wherein the sensor is one of an inertial sensor, an acceleration sensor; and rotation rate sensor.

10. The method according to claim 1, wherein the electronic control unit is one of: an electronic control unit of the driver assistance system, an electronic control unit of a safety system.

11. The method according to claim 10, wherein the algorithm for the temperature compensation is implemented in one of the driving assistance program and safety program.

12. A device for a vehicle comprising:
a sensor having predetermined temperature compensation data stored in readable fashion in a memory unit; and
an electronic control unit with instructions for:
making the stored temperature compensation data are made available to an algorithm for the temperature; and
performing the algorithm for the temperature compensation on the basis of the predetermined temperature compensation data.
